(19) United States
(12) Patent Application Publication
(10) Pub. No.: US 2007/0264506 A1
(43) Pub. Date: Nov. 15, 2007

(54) Epoxy Resin Compositions Containing Mannich Bases, Suitable for High-Temperature Applications

(76) Inventor: Thomas Wigger, Aesch bei Birmensdorf (CH)

Correspondence Address: OLIFF & BERRIDGE, PLC, P.O. BOX 19928, ALEXANDRIA, VA, 22320, US

(21) Appl. No.: 10/552,481

(22) PCT Filed: May 4, 2004
(86) PCT No.: PCT/EP04/50698

§ 371 Date: Mar. 14, 2007

(30) Foreign Application Priority Data
May 5, 2003 (EP) 03010131.5

(51) Int. Cl. C08G 59/62; C09J 163/00

(52) U.S. Cl. 428/413; 156/330; 528/107

(57) ABSTRACT

The invention relates to two-component epoxy resin compositions which contain at least one Mannich base in the hardener component and are provided with a glass transition temperature of more than 80° C. after being cured at a temperature ranging between 5° C. and 60° C. The inventive two-component epoxy resin compositions are used especially as adhesives.

### TECHNICAL FIELD

The invention relates to two-component epoxy resin systems which are cured by cold curing and without subsequent heat treatment have high glass transition temperatures.

### PRIOR ART

Two-component epoxy resin systems have been known for a long time. The first component comprises at least one epoxy resin, while the second component comprises a hardener. When the two components are mixed, epoxy resin and hardener react with one another, producing crosslinking. Amine-based hardeners are widespread. The properties of a cured epoxy resin, however, depend very heavily on the selection of the amines employed, on the application temperature and on the curing temperature.

Epoxy resin systems are much used in order to achieve rigid adhesive bonds. In many cases, bonds of this kind are structural bonds. The domain of use of assemblies featuring such bonds is very diverse and encompasses very different temperature ranges. Particularly for use at high temperatures, the glass transition temperature of the adhesive is an extremely important factor. On exceeding the glass transition temperature the adhesive undergoes a marked change in its properties, as a result of which it is not possible to ensure a secure and long-term bond.

Efforts have therefore been made increasingly to develop epoxy resin systems which have a high glass transition temperature. High glass transition temperatures have been successfully realized by means of thermosetting epoxy resin systems. In the case of thermosetting epoxy systems, temperatures of significantly higher than 100° C. are typically employed. For example, under the influence of dicyanamide (dicy), epoxy resin can be cured at temperatures of usually above 120° C. Curing at such high temperatures, however, is in many cases impossible or undesirable.

Furthermore, it is known that in the case of numerous epoxy resin adhesives, applied at room temperature or slightly elevated temperatures, the glass transition temperature can be raised by a subsequent heat treatment. In this case, for example, an epoxy resin adhesive is applied at room temperature and, after it has attained a certain early strength, is stored overnight or for a number of days in a heating chamber at temperatures, for example, of 100° C. Increasing the glass transition temperature of the adhesive by means of heat treatment, has its limits, imposed by the material. Furthermore, it is virtually impossible for large parts, let alone built structures, to be moved into a heating chamber or artificially heated extensively.

Especially in the case of the adhesive bonding of large components or in the case of outdoor applications in construction and civil engineering, therefore, there is an increasing requirement for cold-curing adhesives which, following mixing, application, and curing at room temperature or slightly elevated temperatures, have a high glass transition temperature. The intention in this case is that there should be no need for additional supply of artificially generated heat in the form of a heat cure or in the form of subsequent heat treatment.

### SUMMARY OF THE INVENTION

It is an object of the present invention to provide a two-component epoxy resin composition which after curing at a temperature between 5° C. and 60° C. has a high glass transition temperature.

Surprisingly it has been found that this can be achieved through the use of at least one Mannich base in the hardener component.

With a two-component epoxy resin composition of this kind it is possible to formulate systems fit for practice which on the one hand cure at room temperature and on the other hand, after curing, have glass transition temperatures of higher than 80° C. without need for subsequent heat treatment, leading to the reliable use of these epoxy resin compositions even at relatively high temperatures.

The glass transition temperature can be measured in a number of different ways. Depending on the method employed, however, the values determined may vary. Consequently, here and below, by ‘glass transition temperature’, also referred to as ‘Tg’, is meant the values determined by means of DSC from half the height in accordance with pr EN 12614.

Hence it is made possible to use epoxy resin compositions even for those applications where conventional heat curing or heat treatment is not possible or is undesirable.

### WAY OF PERFORMING THE INVENTION

The present invention relates to a two-component epoxy resin compositions which in the hardener component comprise at least one Mannich base and which after curing at a temperature between 5° C. and 60° C. have a glass transition temperature of more than 80° C.

Suitable Mannich bases can be prepared from phenolic compounds, formaldehyde, and polyamines.

Particularly suitable phenolic compounds are those which have unsubstituted positions in position o and/or p with respect to the phenol group. Examples thereof are hydroxynaphthalenes, polyhydroxynaphthalenes, alkylphenols, dialkylphenols, bridged phenols, such as tetrahydronaphthols, for example. Polyphenolic compounds as well, both mononuclear and polynuclear, are also encompassed. Examples of such polyphenolic compounds are pyrocatechol, resorcinol, pyrogallol, phloroglucinol, bisphenol A and bisphenol F.

Mannich bases which have been found particularly suitable are those prepared using a phenolic compound of the formula (I) or (II)

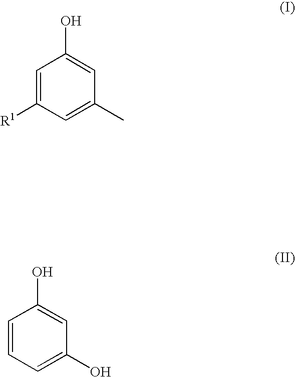

and also formaldehyde and at least one polyamine, with R¹ here being H or CH₃.

Considered particularly preferred is m-cresol, where in formula (I) R¹ is a hydrogen atom.

Formaldehyde can be employed in the forms that are common knowledge to the person skilled in the art, directly, or from formaldehyde donor compounds. Preference is given to formaldehyde in the form of paraformaldehyde or in the form of formalin solution. Formalin solution is particularly preferred.

By ‘polyamine’ is meant a compound which has two or more primary amino groups. Polyamines of this kind are known to the person skilled in the art in the field of epoxide chemistry and polyurethane chemistry as crosslinking agents. Particular suitability is possessed by

Aliphatic polyamines such as ethylenediamine, 1,2- and 1,3-propanediamine, 2-methyl-1,2-propanediamine, 2,2-dimethyl-1,3-propane-diamine, 1,3- and 1,4-butanediamine, 1,3- and 1,5-pentanediamine, 1,5-diamino-2-methylpentane (MPMD), 1,6-hexanediamine, 2,2,4- and 2,4,4-trimethylhexamethylenediamine, 1,7-heptanediamine, 1,8-octanediamine, 4-aminomethyl-1,8-octanediamine, methylbis(3-aminopropyl)amine, 1,3-diaminopentane (DAMP), 2,5-dimethyl-1,6-hexamethylenediamine, diethylenetriamine, triethylenetetramine (3,6-diaza-octamethylenediamine), tetraethylenepentamine, pentamethylenehexamine, dipropylenetriamine, tripropylenetetramine, tetrapropylenepentamine, 4,7-diaza-decamethylene-1,10-diamine, and mixtures of the aforementioned polyamines.

cycloaliphatic polyamines such as 1,3- and 1,4-diaminocyclohexane, 1,2-diaminocyclohexane (DCH), bis(4-aminocyclohexyl)methane (PACM), bis(4-amino-3-methylcyclohexyl)methane, bis-(4-amino-3-ethylcyclohexyl)-methane, bis(4-amino-3,5-dimethylcyclohexyl)methane, 1-amino-3-amino-methyl-3,5,5-trimethylcyclohexane (=isophoronediamine or IPDA), 2- and 4-methyl-1,3-diaminocyclohexane, 1,3- and 1,4-bis(aminomethyl)cyclohexane, 1,3-2,5(2,6)-bis-(aminomethyl)bicyclo[2.2.1]heptane (NBDA, produced by Mitsui Chemicals), 3(4),8(9)-bis(aminomethyl)tricyclo[5.2.1.0^{2,6}]decane, 3,9-bis(3-aminopropyl)-2,4,8,10-tetraoxaspiro[5.5]undecane, 1,3- and 1,4-xylylene-diamine, octahydro-4,7-methano-indene-2,5-diamine, octahydro-4,7-methano-indene-1,6-diamine, aliphatic polyamines containing ether groups, such as bis-(2-aminoethyl)ether, and higher oligomers thereof, and also mixtures of the aforementioned polyamines.

aromatic amines such as tolylenediamine, phenylenediamine, 4,4-methylenedianiline (MDA), and mixtures of the aforementioned polyamines.

Preference is given to polyamines selected from the group encompassing DAMP, IPDA, 1,3- and 1,4-diaminocyclohexane, 1,2-diamino-cyclohexane, 1,3- and 1,4-butanediamine, 1,3- and 1,5-pentanediamine, MPMD, 1,3-xylylenediamine, 1,3-bis(aminomethyl)cyclohexane, diethylene-triamine, triethylenetetramine (3,6-diaza-octamethylenediamine), tetraethylenepentamine, pentamethylenehexamine, dipropylenetriamine, tripropylenetetramine, tetrapropylenepentamine, 4,7-diaza-decamethylene-1,10-diamine, bis(4-aminocyclohexyl)methane, bis(4-amino-3-methyl-cyclohexyl)methane, 3(4),8(9)bis(aminomethyl)tricyclo[5.2.1.0^{2,6}]decane, and mixtures thereof.

With particular preference the polyamines are selected from the group encompassing 1,3-xylylenediamine, 1,3-bis(aminomethyl)cyclohexane, diethylenetriamine, triethylenetetramine (3,6-diaza-octamethylenediamine), tetraethylenepentamine, IPDA, 1,2-diaminocyclohexane, 4,7-diaza-decamethylene-1,10-diamine, and mixtures thereof.

It will be appreciated that mixtures of such polyamines with other polyamines or other amines are also possible.

Mannich bases can be prepared from phenolic compounds, formaldehyde, and polyamines. It is possible to prepare Mannich bases by customary processes.

It has been found that a two-stage preparation process is of advantage. In this case, in a first stage, the phenolic compound, particularly a phenolic compound of the formula (I) or (II), is reacted with formaldehyde under the influence of a base. This base may be a tertiary amine, alkali metal hydroxide, alkaline earth metal hydroxide, or mixtures thereof. Particularly suitable are tertiary amines, especially tertiary amines which additionally contain primary amino groups, such as 1-(2-aminoethyl)piperazine for example. Preferred tertiary amines are those of the formula (III), in which the radicals R² are a C₁-C₆-alkyl and n=1, 2, or 3.

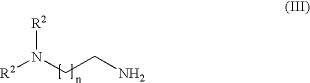

Preference as R² is given to R²=methyl or ethyl, especially R²=methyl. Preference as n is given to n=2.

Advantageously, in the first stage, the formaldehyde is added to a mixture of the phenolic component and the base, in particular to a mixture of the phenolic compound of the formula (I) or (II) and a tertiary amine. The addition is advantageously made such that, with cooling, the formaldehyde, which is likewise cooled, is added slowly, so that only a slight temperature increase is recorded.

In a second stage a reaction is carried out with at least one polyamine. Advantageously, in the second stage, the product resulting from the first stage is added slowly to the polyamine.

To the person skilled in the art it is clear that in the case of this kind of reaction it is also possible for unreacted constituents to be present to a small extent in the end product.

Under certain conditions, however, even one-stage processes, in which phenolic component, formaldehyde and polyamine are reacted, lead to Mannich bases which can be used in inventive epoxy resin compositions.

The Mannich base contains not only secondary amino groups but also primary amino groups.

The Mannich base advantageously contains no polynuclear oligomers, or at least a small fraction of polynuclear oligomers. The oligomers fraction is preferably less than 20% by weight, in particular less than 10% by weight based on the weight of the Mannich base.

It is further advantageous if the Mannich base contains less than 1% by weight, in particular less than 0.5% by weight, preferably less than 0.1% by weight, of unreacted phenolic compound, based on the weight of the Mannich base.

The Mannich base advantageously has a low viscosity. Particularly suitable for formulating adhesives are viscosities of 200 to 1000 mPas, in particular between 200 and 700 mPas.

The Mannich base described is part of the hardener component of a two-component epoxy resin composition. It may occur alone or mixed, in conjunction with other constituents customary in hardener components for two-component component epoxy resin compositions. Particularly suitable for this purpose are other amines, especially polyamines, adducted amine hardeners, accelerants, adjuvants such as additives, pigments, and fillers. Preferred accelerants are tris(2,4,6-dimethylaminomethyl)phenol and aminoethylpiperazine. Extenders or diluents are also possible, though in those cases great care must be taken to ensure that the attendant reduction in the glass transition temperature is not so great that the glass transition temperature of the cured epoxy resin composition comes to be situated lower than the planned service temperature of the epoxy system.

A hardener component of this kind can be prepared in customary agitators.

The two-component epoxy resin composition of the invention has a resin component. This resin component encompasses epoxy resins. Epoxy resins are the epoxy resins known to the person skilled in the art of epoxy resin, particularly the epoxy resins based on diglycidyl ethers of bisphenol A, bisphenol F, and bisphenol A/F mixtures. As well as the liquid resins, the solid resins, in particular, are of great importance. Of particular interest are novolak resins. Furthermore reactive diluents are customary constituents of the resin component. Preference is given to reactive diluents having two or more, especially two or three glycidyl groups. Additionally suitable reactive diluents are N-glycidyl ethers, which can be prepared as a reaction product from epichlorohydrin and amines. Amines suitable for this reaction are aniline, m-xylylenediamine (MXDA), 4,4-methylenedianiline (MDA), or bis(4-methyl-aminophenyl)methane. Particularly suitable N-glycidyl ethers are p-hydroxy-aminobenzene-triglycidyladduct, MXDA-tetraglycidyladduct, and MDA-tetra-glycidyladduct.

Further constituents may be extenders, diluents, accelerants, adjuvants such as additives, pigments, and fillers. When using reactive diluents, extenders, and other diluents great care must be taken to ensure that the attendant reduction in the glass transition temperature is not so great that the glass transition temperature of the cured epoxy resin composition comes to be situated lower than the planned service temperature of the epoxy system.

An epoxy resin component of this kind can be prepared in customary agitators.

The mixing ratio of epoxy resin component and hardener component is advantageously to be chosen such that, in the manner known to the person skilled in the art, epoxide groups and amine groups react stoichiometrically with one another. It is, however, also possible to deviate from this ratio and in certain circumstances to undercure or overcure by up to about 20%.

The two components can be mixed by hand or by machine. Unfilled systems or slightly pasty systems can be mixed readily using stirrers or mixing devices such as 2C cartridge guns or with pumps in combination with static mixers or dynamic mixers. Highly filled systems are advantageously mixed by means of stirrers, by hand, or by agitator.

The possible uses of the two-component epoxy resin composition of the invention are diverse. For instance, its use as a coating, varnish, covering, sealant or adhesive is possible. Its use as an adhesive, in particular, is of particular interest. Particular preference attaches to its use as an adhesive for application in construction or civil engineering. Particularly important is its use as an adhesive for static reinforcement. An important application is its use as a structural adhesive.

For use as an adhesive, the two-component epoxy resin composition is mixed and applied at least to one solid's surface and then contacted with a further solid's surface. It is also possible for the adhesive to be injected into a gap and cured therein. After the curing of the epoxy resin composition, an adhesive bond produced in this way can be subjected to load. It is entirely possible for several weeks to elapse until the maximum strength is attained.

It has further been found that these systems have longer pot lives than known Mannich bases prepared by means of conventional techniques from phenol, p-tert-butylphenol, nonylphenol and/or bisphenol A and also polyamines.

The two-component epoxy resin composition is mixed and applied. It can be cured cold, i.e., cured at temperatures between 5° C. and 60° C. Advantageously the components are likewise mixed and applied at temperatures between 5 and 60° C.

These temperatures describe the ambient temperatures at which an adhesive is customarily applied and cured, especially in construction and civil engineering. Particular importance attaches to the range between 10° C. and 50° C., in particular the range between 10° C. and 30° C. Application at temperatures in the region of room temperature is particularly common. For the properties of the cured epoxy resin composition, the cure temperature in particular is relevant. Consequently, curing at a temperature between 10° C. and 50° C., in particular between 10° C. and 30° C., is preferred.

The foregoing of artificially supplied heat reduces application costs and fabrication costs. Extensive objects, moreover, are difficult if not impossible to heat artificially using customary means. The absence of the need for such artificially generated, extensive heating permits, for the first time, applications on large objects, such as are customary in construction or civil engineering.

At temperatures lower than 5° C., adequate curing is not ensured. In the case of using temperatures higher than 60° C., it is necessary to use artificial heat sources. To the person skilled in the art it is clear that mixing, application, and curing are also possible at higher temperatures. The adaptations of pot life and viscosities that are the most that is necessary for this purpose can be achieved by means of techniques that are known to the person skilled in the art. It is also possible to carry out a subsequent heat treatment. In these cases as well, glass transition temperatures of higher than 80° C. can be realized. To the person skilled in the art it is likewise clear that the cured two-component epoxy resin composition need not necessarily be employed at relatively high service temperatures. A cold-cured two-component epoxy resin composition of this kind may well be used at room temperature.

The two-component epoxy resin compositions of the invention are typically mixed at room temperature or at slightly elevated temperature, applied and then cured at this ambient temperature. After curing, during service of the cured epoxy resin, the temperature may reach close to the glass transition temperature without the mechanical properties being too sharply adversely affected. Particularly in the case of use of the epoxy resin composition as an adhesive, the transmission of force between the adherends at the service temperature must not be markedly impaired, or adhesion failure or adhesive creep occurs.

After curing, the two-component epoxy resin compositions of the invention have a glass transition temperature of more than 80° C., preferably more than 100° C., in particular in the range between 100° C. and 150° C.

A two-component epoxy resin composition of the invention can be used for example as an adhesive for bonding fiber-reinforced composites. One illustrative example of this is the adhesive bonding of carbon fiber lamellae in connection with the strengthening of built structures, such as bridges.

Furthermore, two-component epoxy resin compositions of the invention can be used as a polymeric matrix for producing fiber-reinforced composites. For example, carbon fibers or glass fibers can be embedded in a two-component epoxy resin composition and can be employed in the cured state as a fiber composite, in the form of a lamella for example.

It is likewise possible, for example, to use a two-component epoxy resin composition to apply fiber wovens or fiber lays to a built structure, and to form, together with the built structure, a fiber-reinforced composite there.

### EXAMPLES

The examples given below serve to illustrate the invention.

### Example of a Two-Stage Mannich Base Preparation

### Preparation 1st Stage

86.4 g of m-cresol were charged to a glass flask and 81.3 g of 1,3-N,N-dimethylaminopropylamine were added. The mixture was cooled to 20° C. and then 197 g of cold formalin solution (36.5% in water) was slowly added dropwise with cooling. A marked exotherm occurred. The internal temperature was held at between 40° C. and 45° C. After the end of the addition, stirring was continued at 40-45° C. for 1 hour.

### Preparation 2nd Stage

The polyamine indicated in Table 1 was charged to the reactor under nitrogen RT and heated to 80° C. and the intermediate resulting from the first stage was poured in slowly with stirring. A mild exotherm occurred. Heating took place under nitrogen to approximately 110° C. and at the same time the water of reaction was distilled off under atmospheric pressure. After 80% of the theoretical amount of water of reaction, vacuum was applied and distillated removal took place up to the theoretical amount of water.

### Example of a One-Stage Mannich Base Preparation

342 g of 1,2-diaminocyclohexane (DCH), 129 g of aminoethylpiperazine, and 122 g of 3,5-xylenol were introduced into a vessel. With cooling, at a temperature of 20 to 30° C., 197 g of cold formalin solution (36.5% in water) were added dropwise. A considerable exotherm occurred. Heating took place to approximately 110° C. under nitrogen, and at the same time the water of reaction was distilled off under atmospheric pressure. After 80% of the theoretical amount of water of reaction, vacuum was applied and distillated removal took place up to the theoretical amount of water.

TABLE 1
Mannich bases and references

| | | Amount of polyamine used in | Viscosity |
|---|---|---|---|
| Designation | Polyamine | 2-stage preparation (g) | (mPas) |
| MB1 | DETA | 330 | 288 |
| MB2 | Laromin 0260 | 638 | 14180 |
| MB3 | DCH | 306 | 466 |
| MB4 | IPD | 457 | 3272 |
| MB5 | MXDA | 365 | 772 |
| Ref. 1 | Laromin C260 | — | 151 |
| Ref. 2 | IPD | — | 19 |

Table 1 shows the properties of the Mannich bases after cooling to room temperature. The stated viscosities relate to a blend with 5% by weight of accelerant tris-(2,4,6-dimethylaminomethyl)phenol (Araldite HY-960, Vantico). The viscosity was determined by rotational viscometry using a Rheomat (cone/plate) in accordance with DIN EN ISO 3219. Ref. 1 and Ref. 2, as comparison, are not Mannich bases, but rather amines.

Table 2 shows the properties of two-component epoxy resin compositions. The epoxy resin component in this case is in each case a mixture consisting of 85% of bisphenol A diglydiyl ether (available commercially from Vantico as Araldite GY-250) and 15% of trimethylolpropane triglycidyl ether. Compositions were mixed at 20 to 23° C. and 50% relative atmospheric humidity with a hardener consisting of 95% by weight of the Mannich base or polyamine and 5% by weight of tris-(2,4,6-dimethylaminomethyl)phenol (Araldite HY-960, Vantico), mixing taking place stoichiometrically in respect of amine-H/epoxy groups, and the composition was cured under these conditions for 7 days.

TABLE 2
Properties of the compositions.

| Designation | Pot life | Tg (° C.) |
|---|---|---|
| MB1 | 20 min | 103 |
| MB2 | 1 h 54 min | 105 |
| MB3 | 47 min | 128 |
| MB4 | 48 min | 122 |
| MB5 | 27 min | 109 |
| Ref. 1 | 4 h 49 min | 59 |
| Ref. 2 | 1 h 37 min | 73 |

The pot life of a 100 g mixture was determined in an insulated cylindrical cup at 23° C. by means of a gel timer.

The glass transition temperature (Tg) was determined in accordance with EN 12614 by means of DSC. For this purpose the cured sample was first cooled to +5° C. and then heated at a rate of 10 K/minute to 160° C. (relaxation of the polymer structure) in a first run. Thereafter the sample was cooled at 50 K/minute to +5° C., held at 5° C. for 10 minutes, and heated in a second run at a rate of 10 K/minute to 160° C. From the measurement diagram for the second run the glass transition temperature (Tg) was determined from half the height.

Tables 1 and 2 show that the Mannich bases can be prepared, on the one hand having a low viscosity, and on the other hand that with compositions comprising such Mannich bases, in contrast to known cold-curing polyamines, (Ref. 1 and Ref. 2), higher glass transition temperatures can be achieved.

Table 3 shows hardeners which represent a blend of Mannich bases with polyamines.

TABLE 3
Properties of Mannich base/polyamine blends.

| | Mannich | Mannich | |
|---|---|---|---|
| | base/polyamine | base/polyamine | Viscosity |
| Designation | mixture | ratio w:w | (mPas)* |
| MB6 | MB1/DETA | 1:1 | 51 |
| MB7 | MB3/DETA | 1:1 | 29 |
| MB8 | MB1/DCH | 1:1 | 30 |

*Determined as a blend with 5% by weight of accelerant, tris(2,4,6-dimethylaminomethyl)phenol (Araldite HY-960, Vantico)

Table 4 shows the properties of two-component epoxy resin compositions comprising Mannich base/polyamine hardeners from Table 3. The method used to determine these values has already been described.

TABLE 4
Properties of compositions comprising Mannich
base/polyamine blends.

| | | Tg |
|---|---|---|
| Designation | Pot life | (° C.) |
| MB6 | 32 min | 98 |
| MB7 | 27 min | 110 |
| MBB | 55 min | 108 |
| Ref. 1 | 4 h 49 min | 59 |
| Ref. 2 | 1 h 37 min | 73 |

Tables 4 and 5 show that blends of Mannich bases with polyamines also lead having the desired properties. It is apparent, however, that the blending of polyamines leads to a reduction in the glass transition temperature. Consequently, attention must be paid to the amount and identity of the added polyamine.

Table 5 shows the properties of the Mannich bases prepared in accordance with a one-stage or two-stage process, and, respectively, the properties of a two-component epoxy resin composition comprising them. The method used to determine these values has already been described.

TABLE 5
Comparison of one-stage and two-stage preparation process.

| | | | Phenolic | Viscosity * | |
|---|---|---|---|---|---|
| Designation | Stages | Polyamine | compound | (mPas) | Tg |
| MB3 | 2 | DCH | m-cresol | 466 | 128 |
| MB9 | 2 | DCH | 3,5-xylenol | 497 | 125 |
| MB10 | 1 | DCH | 3,5-xylenol | 2036 | 93 |

* Determined as a blend with 5% by weight of accelerant, tris-(2,4,6-dimethylaminomethyl)phenol (Araldite HY-960, Vantico)

From Table 5 it is apparent that not only one-stage but also two-stage processes lead to suitable Mannich bases and, respectively, to suitable compositions, but that the two-stage process is advantageous in terms of both viscosity and glass transition temperature.

### Examples

### Use as Adhesive

The following hardener components, indicated in Table 6, were prepared. They were cured together with the epoxy resin component already described. In the case of the filled component, curing in ex. 4 was likewise carried out using a filled resin component consisting of 25% by weight of resin, 60% by weight of quartz sand, and 15% by weight of quartz flour.

The tensile strength was determined on test specimens cured at 23° C. and 50% relative atmospheric humidity for 7 days, in accordance with ISO 527, with a tension speed of 5 mm/min.

The steel adhesion was determined on adhesively bonded steel test specimens which were cured at 23° C. and 50% relative atmospheric humidity for 7 days, in accordance with ISO 4624, at 100 N/s.

TABLE 6
Compositions as adhesive.

| | ex. 1 | ex. 2 | ex. 3 | ex. 4 |
|---|---|---|---|---|
| Hardener component | | | | |
| MB1 (% by weight) | 95 | — | — | — |
| MB6 (% by weight) | — | — | — | 21 |
| MB7 (% by weight | — | 95 | — | — |
| MB8 (% by weight | — | — | 95 | — |
| Tris(2,4,6-dimethylamino- | 5 | 5 | 5 | — |
| methyl)phenol (% by weight) | | | | |
| Quartz sand (% by weight) | — | — | — | 32 |
| Quartz flour (% by weight) | — | — | — | 47 |
| Tensile strength (MPa) | 31 | 41 | 10 | 25 |
| Steel adhesion (MPa) | | | | 39 |
| Tg (° C.) | 101 | 110 | 108 | 100 |

1. A two-component epoxy resin composition, characterized in that it comprises in the hardener component at least one Mannich base and after curing at a temperature between 5° C. and 60° C. has a glass transition temperature of more than 80° C.

2. The two-component epoxy resin composition as claimed in claim 1, characterized in that the Mannich base is prepared using a phenolic compound of the formula (I) or (II) 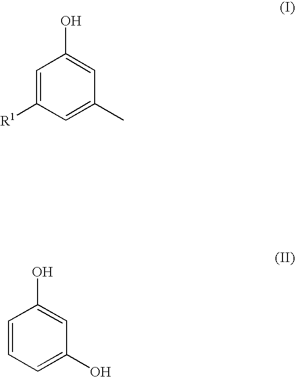
with R¹=H or CH₃,
and also formaldehyde and at least one polyamine.

3. The two-component epoxy resin composition as claimed in claim 1, characterized in that the Mannich base is prepared using a phenolic compound of the formula (I) with R¹=H.

4. The two-component epoxy resin composition as claimed in any claim 1, characterized in that, for the preparation of the Mannich base, in a first stage at least one phenolic compound of the formula (I) or (II) is reacted with formaldehyde in the presence of a tertiary amine and in a subsequent stage reaction takes place with at least one polyamine.

5. The two-component epoxy resin composition as claimed in claim 4, characterized in that the tertiary amine has the formula (III) 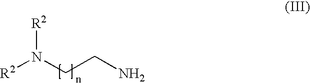
with R²=C₁-C₆ alkyl and n=1, 2, or 3.

6. The two-component epoxy resin composition as claimed in claim 1, characterized in that the Mannich base contains not only secondary but also primary amino groups.

7. The two-component epoxy resin composition as claimed in claim 1, characterized in that the polyamines selected from the group encompassing DAMP, IPDA, 1,3- and 1,4-diaminocyclohexane, 1,2-diamino-cyclohexane 1,3- and 1,4-butanediamine, 1,3- and 1,5-pentanediamine, MPMD, 1,3-xylylenediamine, 1,3-bis(aminomethyl)cyclohexane, diethylenetriamine, triethylenetetramine (3,6-diaza-octamethylenediamine), tetraethylenepentamine, pentamethylenehexamine, dipropylenetriamine, tripropylenetetramine, tetrapropylenepentamine, 4,7-diaza-decamethylene-1,10-diamine, bis(4-aminocyclohexyl)methane, bis(4-amino-3-methyl-cyclohexyl)methane, 3(4),8(9)bis(aminomethyl)tricyclo[5.2.1.0^{2,6}]decane, and mixtures thereof.

8. The two-component epoxy resin composition as claimed in claim 1, characterized in that the polyamine is selected from the group encompassing 1,3-xylylenediamine, 1,3-bis(aminomethyl)cyclohexane, diethylene-triamine, triethylenetetramine (3,6-diazaoctamethylenediamine), tetraethylenepentamine, IPDA, 1,2-diaminocyclohexane, 4,7-diaza-decamethylene-1,10-diamine, and mixtures thereof.

9. The two-component epoxy resin composition as claimed in claim 1, characterized in that curing takes place at a temperature between 10° C. and 50° C., in particular between 10° C. and 30° C.

10. The two-component epoxy resin composition as claimed in claim 1, characterized in that, after curing, the glass transition temperature is above 100° C., in particular between 100° C. and 150° C.

11. The use of a two-component epoxy resin composition as claimed in claim 1 as an adhesive.

12. The use of a two-component epoxy resin composition as claimed in claim 11, characterized in that the adhesive is used for structural reinforcement.

13. The use of a two-component epoxy resin composition as claimed in claim 12, characterized in that the adhesive is used for bonding fiber-reinforced composites to built structures.

14. The use of a two-component epoxy resin composition as claimed in claim 1 as a polymeric matrix for producing fiber-reinforced composites.

15. A fiber-reinforced composite, characterized in that it is produced using a two-component epoxy resin composition as claimed in claim 1.

16. A method of adhesive bonding, characterized in that a two-component epoxy resin composition as claimed in claim 1 is mounted to at least one solid's surface and subsequently contacted with at least one further solid's surface.

17. A cured product obtained from a two-component epoxy resin composition as claimed in claim 1.
